(19) United States
(12) Patent Application Publication
(10) Pub. No.: US 2009/0219199 A1
(43) Pub. Date: Sep. 3, 2009

(54) Positioning system for projecting a site model

(75) Inventors: Joanne Charlotte Borchert, Peoria, IL (US); Stephen Ray Fouts, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 12/073,147

(22) Filed: Feb. 29, 2008

(51) Int. Cl. G01S 5/00; G06T 15/00

(52) U.S. Cl. 342/357.07; 345/419

(57) ABSTRACT

A positioning system is disclosed. The positioning system has a database for storing a site model. The site model has data indicative of a desired geography of a site environment and an actual geography of the site environment. The positioning system also has a first receiver for generating digital signals representing a real time position in three-dimensional space of at least a portion of a machine as the machine traverses the site environment. The positioning system further has a processor for receiving the signals and updating the site model to determine a difference between the data indicative of the desired geography and the data indicative of the actual geography. The positioning system also has a display for projecting the site model onto at least one surface of an operator station of the machine so that an operator may simultaneously view the site model and the site environment.

### TECHNICAL FIELD

This disclosure relates generally to a positioning system and, more particularly, to a positioning system for projecting a site model.

### BACKGROUND

The construction industry often employs computer systems for digitally mapping work sites, particularly for operations such as earth-moving. To facilitate digital mapping, construction personnel typically provide earth-moving machines with global positioning systems (GPS). As an alternative to employing standard surveying teams, construction personnel use a machine with GPS to produce an initial survey of a work site. The machine with GPS moves back and forth across a worksite, collecting three-dimensional GPS coordinates and providing the data to a computer. The computer, which may be located on board of the machine or located remotely, inputs the data into a software application or algorithm to create a three-dimensional model of the actual contours of the worksite. This model provides the initial survey of the work site.

Construction personnel also provide input to the computer corresponding to a final desired design plan for the work site. The computer compares the actual terrain contours and the design plan contours to verify the total amount of earth-moving that construction personnel must perform. When operations such as earth-moving begin, a number of machines with GPS may transmit updated GPS information to the computer, which uses the new coordinates to constantly update the actual contours of the terrain map. The computer periodically compares the actual contours to the design plan for the work site. The computer typically provides the terrain map data to construction personnel through a conventional computer monitor display. The computer displays highlighted areas of the work site that need work such as cutting or filling. Construction personnel use the display to verify the progress of construction work such as, for example, earth-moving. Since construction personnel have substantially real time comparison of actual contours to design plans, they can determine if machines are working in the correct locations.

One shortcoming of the above-described scheme is the difficulty operators have when looking back and forth between the display monitor and the actual worksite visible through the windows of his machine. The display may show a large amount of precise plan lines, which may be difficult for an operator to mentally transpose between the display and the physical changes he is making to the worksite. Additionally, continuously glancing back and forth between the display and the actual worksite for long periods of time may become mentally exhausting and may cause the operator to work less efficiently.

U.S. Pat. No. 5,751,576 (the '576 patent), issued to Monson, discloses an animated map display method for an agricultural product application. The '576 patent describes an animated map display transposing information related to geological or environmental features, physical structures, sensor signals, status information, and other data for distributing an agricultural product onto a field. The data is displayed as a two- or three-dimensional representation that is projected using a heads-up display (HUD) overlaid onto the real-world terrain and environment visible to the operator through the windshield (or windows) of a machine. The animated map display may present information relating to a particular map set as a three-dimensional image corresponding spatially to real-world terrain or environment, as well as including alphanumeric, pictorial, symbolic, color, or textural indicia relating to navigational, sensor, or other data inputs. The machine carries GPS to provide a coordinate location, and conventional computer processes are used to generate the three-dimensional images.

Although the method of the '576 patent may provide a method for displaying agricultural information for two-dimensional operations such as agricultural product placement, it may not provide a method for making calculations for three-dimensional operations and displaying the output from those calculations. The method of the '576 patent may not be configured to display three-dimensional design plans associated with construction work.

The present disclosure is directed to overcoming one or more of the shortcomings set forth above.

### SUMMARY OF THE DISCLOSURE

In accordance with one aspect, the present disclosure is directed toward a positioning system. The positioning system includes a database for storing a site model. The site model includes data indicative of a desired geography of a site environment and an actual geography of the site environment. The positioning system also includes a first receiver for generating digital signals representing a real time position in three-dimensional space of at least a portion of a machine as the machine traverses the site environment. The positioning system further includes a processor for receiving the signals and updating the site model to determine a difference between the data indicative of the desired geography and the data indicative of the actual geography. The positioning system also includes a display for projecting the site model onto at least one surface of an operator station of the machine so that an operator may simultaneously view the site model and the site environment.

According to another aspect, the present disclosure is directed toward a method for providing positioning data to an operator. The method includes storing data indicative of a desired geography of a site environment. The method also includes storing data indicative of an actual geography of the site environment. The method further includes receiving a real time position in three-dimensional space of at least a portion of a machine as the machine traverses the site environment. The method additionally includes updating the data indicative of the actual geography of the site based on the real time position. The method also includes determining a difference between the data indicative of the desired geography and the data indicative of the actual geography in real time. The method further includes updating and storing the difference. The method additionally includes projecting data onto at least one surface of an operator station so that the data indicative of the desired geography, the data indicative of the actual geography, and the difference may be viewed simultaneously with the site environment by an operator.

### BRIEF DESCRIPTION OF THE DRAWINGS

FIG. 1 is a diagrammatic illustration of an exemplary disclosed positioning system;

FIG. 2 is a pictorial illustration of the exemplary disclosed positioning system of FIG. 1;

FIG. 3 is a pictorial illustration of an exemplary disclosed display;

FIG. 4 is a pictorial illustration of an exemplary disclosed display; and

FIG. 5 is a cross-section view of an exemplary disclosed cathode ray tube projector.

### DETAILED DESCRIPTION

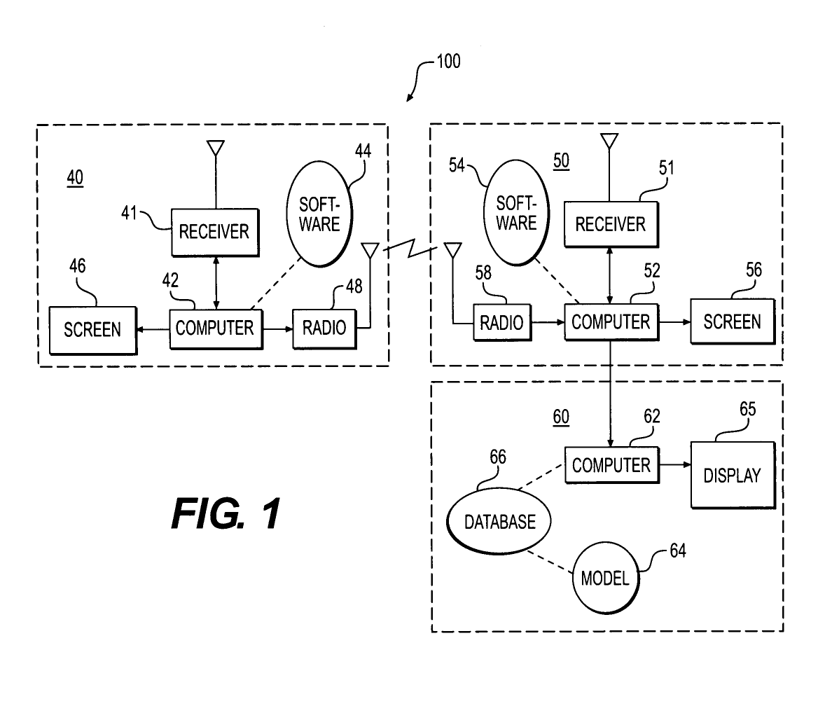

Referring to FIG. 1, a schematic of a three-dimensional positioning system 100 is shown. System 100 may use a differencing algorithm to calculate a machine position and path in real time. System 100 may include a base reference module 40, a position module 50, and an update module 60. Base reference module 40 may be located at a stationary position. Module 40 may be located in a permanent site such as, for example, a building or trailer. Module 40 may be located on a work site 12, or remotely from a work site 12. Module 50 and module 60 may be located on a machine such as, for example, a terrain-altering machine 10. Module 40 and module 50 may together be configured to determine three-dimensional coordinates of terrain-altering machine 10 relative to work site 12, while an update module 60 may convert these three-dimensional coordinates, e.g., position information, into real time representations of the site, which may be used to monitor and control machine 10.

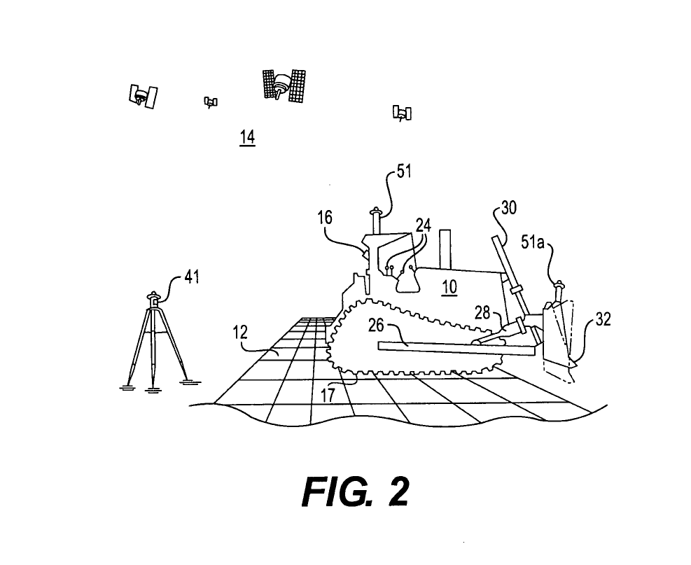

Base reference module 40 may include a stationary GPS receiver 41 for the receipt and processing of GPS signals. Base reference receiver 41 may be a high accuracy kinematic GPS receiver. GPS receiver 41 may include a local reference antenna (not shown) and a satellite antenna (not shown). The satellite antenna may receive signals from global positioning satellites 14 (shown in FIG. 2). GPS receiver 41 may use position signals from the satellite antenna and differential correction signals from the local reference antenna to generate position coordinate data in three-dimensions. Receiver 41 may determine coordinate data within an accuracy of one centimeter. Base reference module 40 may also include a computer 42 for receiving inputs from receiver 41 and reference receiver GPS software 44 that may be temporarily or permanently stored in computer 42. Base reference module 40 may also include a conventional computer monitor screen 46 and a digital transceiver-type radio 48 or other suitable communications device connected to computer 42 and capable of transmitting a digital data stream. It is contemplated that base reference module 40 may help to verify the GPS location of terrain-altering machine 10 relative to work site 12.

Position module 50 may include a kinematic GPS receiver 51, similar to GPS receiver 41. Module 50 may also include a matching computer 52 for receiving input from receiver 51 and kinematic GPS software 54 stored permanently or temporarily on computer 52. Module 50 may further include a standard computer monitor screen 56 and a matching transceiver-type digital radio 58 or other suitable communications device, which receives signals from radio 48 in base reference module 40. It is contemplated that position module 50 may provide updated GPS data relating to the three-dimensional location of machine 10.

Update module 60 may include an additional computer 62 for receiving input from position module 50 and one or more digitized site models 64, which may be digitally stored or loaded into the memory of computer 62. Module 60 may also include a dynamic database 66, also stored or loaded into the memory of computer 62. The data associated with model 64 and database 66 may describe various states of work site 12, in three dimensions. Model 64 may include a three-dimensional model of work site 12 as surveyed, as well as the desired three-dimensional plan of work site 12 during various phases of construction or other activity. Model 64 may also include a three-dimensional model of a final design plan for work site 12. Model 64 may further include updated data from module 50 for constructing a three-dimensional model (updated in real time) reflecting physical changes that machine 10 may make to work site 12. Therefore, at any given time, model 64 may include a current three-dimensional plan of the site. Computer 62 may contain algorithms that compare the actual state of work site 12 to the desired end state of work site 12 to calculate amounts and locations of work that still must be completed (e.g., cut volumes and fill volumes). Module 60 may further include a display 65, which may be connected to computer 62. Display 65 may be a heads-up display, as further described below. It is contemplated that module 60 may maintain an updated three-dimensional model of work site 12 to be used by an operator of machine 10 in completing operations such as, for example, construction work.

In an exemplary embodiment, some or all portions of update module 60 may be stationed remotely from machine 10. For example, computer 62, site model(s) 64, and dynamic database 66 may be connected by radio data link to position module 50 and display 65. Position and site update information may then be broadcast to and from machine 10 for display and/or use by operators or supervisors both on and off the machine. It is contemplated that operators may be located in an operator station 16 of machine 10.

In an exemplary embodiment, base reference module 40 may be fixed at a point of known three-dimensional coordinates relative to work site 12. Through GPS receiver 41, base reference module 40 may receive position information from a GPS satellite constellation, using the reference GPS software 44 to derive an instantaneous error quantity or correction factor. This correction factor is broadcast from module 40 to position module 50 on machine 10 via radio link 48,58. Alternatively, raw position data can be transmitted from base reference module 40 to position module 50 via radio link 48,58, and processed by computer 52. GPS receiver 41 may be positioned in any suitable manner known in the art such as, for example, on a tripod as illustrated in FIG. 2.

In an exemplary embodiment, GPS receiver 51 may receive position information from the satellite constellation. Kinematic GPS software 54 may combine the signal from GPS receiver 51 and the correction factor from base reference module 40 to determine the position of GPS receiver 51 and machine 10 relative to base reference module 40 and work site 12 within a few centimeters (about an inch). It is contemplated that this position information may be three-dimensional (e.g., latitude, longitude and elevation) and may be available on a point-by-point basis according to a sampling rate of the GPS system.

Because the sampling rate of position module 50 results in a time/distance delay between position coordinate points as the machine moves over the site, dynamic database 66 may use a differencing algorithm to determine and update in real time the path of machine 10. Referring to update module 60, once the digitized plans or models of work site 12 have been loaded into computer 62, dynamic database 66 may generate signals representative of the difference between actual and desired site terrain to display this difference graphically on display 65. For example, profile and/or plan views of the actual and desired site models may be combined on display 65 and the elevation difference between their surfaces may be indicated.

Referring to FIG. 2, terrain-altering machine 10 is shown on location at a work site 12. In the exemplary embodiment of FIG. 2, machine 10 may be a track-type tractor which performs earth-moving and contouring operations on work site 12. Machine 10 may be equipped with hydraulic or electrohydraulic tool controls 24. Controls 24 may control the actuation of a push arm 26, tip/pitch cylinders 28, and lift cylinders 30 to maneuver a tool 32 in three dimensions for desired cut, fill and carry operations. GPS receiver 51 may be located on machine 10 at fixed, known coordinates relative to the site-contacting portions of tracks 17. GPS receiver 51a, similar to GPS receiver 51, may be located on tool 32 to provide three-dimensional position information of tool 32.

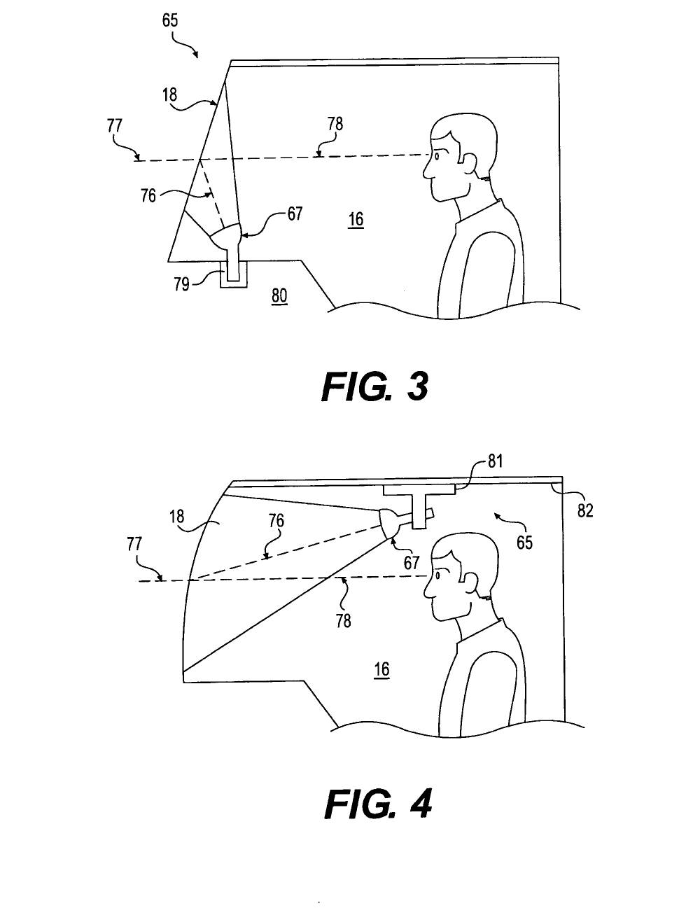

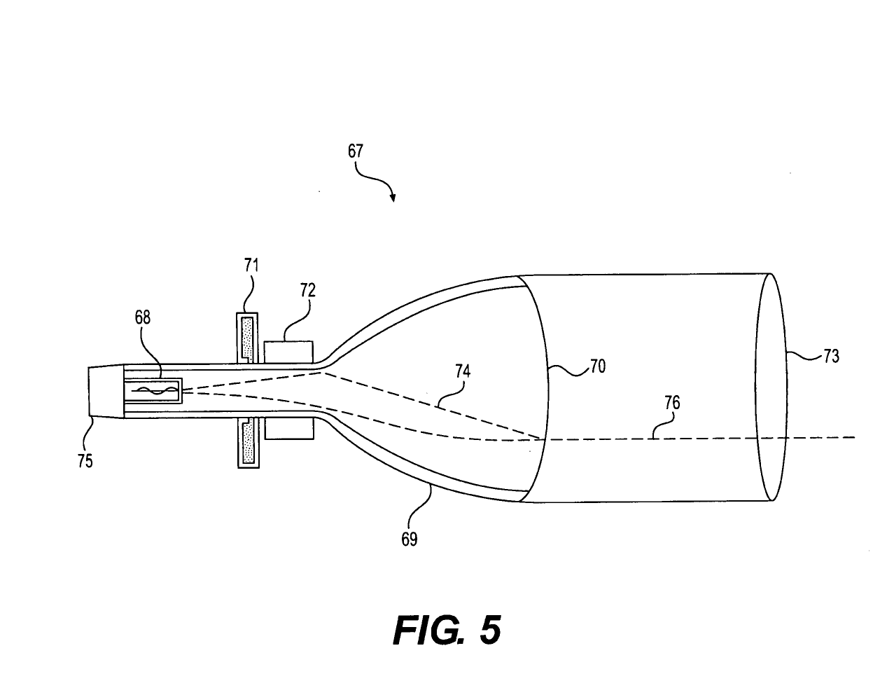

As shown in the exemplary embodiments of FIGS. 3 and 4, display 65 may be a heads-up display that may be seen by operators as they look out of one or more windshields 18 of operator station 16. Heads-up display 65 may project information onto windshields 18 without obstructing the view of the operators. Heads-up display 65 may include a cathode ray tube (CRT) projector 67. CRT projector 67 may be electrically connected to computer 62, and may receive processed data from model 64 and database 66 via computer 62. As shown in FIG. 5, CRT projector 67 may include a symbol generator 75 capable of processing the data from computer 62 for transformation into pixels or graphics. Symbol generator 75 may be electrically connected to a cathode 68. Cathode 68 may be any cathode known in the art, suitable for producing a ray of electrons. Based on the data provided by symbol generator 75, cathode 68 may generate an electron ray 74 that may travel within a glass bulb 69 and strike a glass face 70 of bulb 69. Face 70 may be coated with phosphors (not shown). As electron ray 74 strikes phosphors on face 70, the phosphors may give off light, shown as light ray 76. It is contemplated that display 65 may display some or all of the three-dimensional data maintained by update module 60 to an operator. It is also contemplated that phosphors on face 70 may be configured to give off light of various colors such as, for example, red, green, and blue.

In an exemplary embodiment, CRT projector 67 may include a focusing coil 71, which may be located near cathode 68. Focusing coil 71 may focus ray 74 within bulb 69. CRT projector 67 may also include deflecting plates 72. Deflecting plates 72 may direct ray 74 to a given location on face 70. Depending on the location on face 70 at which ray 74 is directed, light ray 76 may be directed out of CRT projector 67 in a certain direction. The voltage of cathode 68 may also be varied to change the intensity of ray 74. Computer 62 may include algorithms for controlling the components of CRT projector 67 to produce light rays 76 of a given direction and intensity.

Display 65 may be a refractive heads-up display, as shown in FIG. 3. CRT projector 67 may be mounted within a housing 79, attached within a recess of a dashboard 80 of operator station 16. CRT projector 67 may include a collimating lens 73. Collimating lens 73 may be any suitable lens known in the art for transforming light ray 76 into a set of parallel beams. Windshields 18 may be semi-transparent combining glass, upon which the parallel beams of light ray 76 may be projected. Windshields 18 may also be covered with any suitable semi-transparent coating or film known in the art for enhancing the visibility of projections. Outside light 77 may combine with light ray 76 to form combined light 78, which may be reflected to the operator's eyes and allow the operator to view images projected by CRT projector 67 superimposed over the operator's view of the actual terrain surrounding machine 10. An advantage inherent in refractive heads-up display 65 may be that the operator may move his head within operator station 16, while still being able to see the images projected onto windshields 18. For example, the projected site model may be configured to be viewable at various angles by operators as they change their position within operator station 16. It is contemplated that light ray 76 and combined light 78 may include light of various colors such as, for example, red, green, and blue.

CRT projector 67 may project the data, described above, associated with model 64 and database 66 onto windshields 18. CRT projector 67 may project any desired aspect of model 64. In an exemplary embodiment, CRT projector 67 may project the desired end state of work site 12, the actual state of work site 12 (for verification purposes by the operator), or the amount and location of work to be done (based on the calculations comparing the difference between the actual state and end state). It is contemplated that these aspects of model 64 may be color-coded when projected, so that operators may easily distinguish the desired end state, the actual state, and work remaining to be completed. In an exemplary embodiment, aspects of model 64 may be projected in different colors such as, for example, red, green, and blue, by light ray 76 and combined light 78 as described above. Based on the GPS processing defined above, the images may align with the actual terrain visible to the operator outside of operator station 16. Since windshields 18 may be semi-transparent, the operator may simultaneously view a three-dimensional model of a design plan for work site 12 projected onto windshields 18 and the actual terrain visible beyond windshields 18, where the projected terrain appears to overlay the actual terrain in the perspective of the operator.

In a second exemplary embodiment, display 65 may be a reflective heads-up display, as shown in FIG. 4. CRT projector 67 may be attached to a mount 81, where mount 81 may be fastened to a roof 82 of operator station 16. In the second exemplary embodiment, unlike the first refractive embodiment above, collimating lens 73 may not be integral with projector 67. Instead, a collimating lens (not shown) may be integral with windshields 18, where windshields 18 may be curved. Curved windshields 18, having integrated collimating lenses, may reflect ray 76 in a direction different than received. It is contemplated that curved windshield 18 having the integrated collimating lens may be an off-axis mirror that reflects ray 76 so that combined light 78 is visible to operators only at certain locations within operator station 16 (i.e., when the operator's head is at certain locations within operator station 16). Outside light 77 may combine with light ray 76 to form combined light 78, which may be reflected to the operator's eyes and allow the operator to view images projected by CRT projector 67, similar to the refractive heads-up display described above.

### INDUSTRIAL APPLICABILITY

The exemplary disclosed positioning system and associated display may help to provide a method for calculating and displaying a site model to an operator. The disclosed positioning system and display may project the site model onto windshields of an operator station so that operators may compare the projected model with the actual conditions of a work site, allowing them to work more efficiently.

Machine-mounted GPS receiver 51 may receive position signals from satellites 14 and an error correction signal from GPS receiver 41 via radios 48,58 as shown in FIGS. 1 and 2. GPS receiver 51 may use the signals from satellites 14 and GPS receiver 41 to accurately determine its position in three-dimensional space. Alternatively, raw position data may be transmitted from GPS receiver 41, and processed in known fashion by the machine-mounted receiver system to achieve the same result. Using kinematic GPS or other suitable three-dimensional position signals from an external reference, the location of GPS receiver 51 and machine 10 may be accurately determined on a point-by-point basis within a few centimeters as machine 10 moves over work site 12. The sampling rate for coordinate points using positioning system 100 may be approximately one point per second.

The coordinates of GPS receiver 41 may be determined in any known fashion, such as GPS positioning or conventional surveying. Work site 12 may be previously surveyed to provide a detailed topographic blueprint (not shown) showing the architect's finished site plan overlaid on the original site topography in plan view. The creation of geographic or topographic blueprints of sites such as landfills, mines, and work sites with optical surveying and other techniques is a well-known art. For example, reference points may be plotted on a grid over the site and may be connected or filled in to produce the site contours on the blueprint. The detail of the map may increase with the amount of reference points taken. The map may be associated with model 64 and stored within database 66.

Systems and software may be currently available to produce digitized, two- or three-dimensional maps of a geographic site. For example, the architect's blueprint may be converted into three-dimensional digitized models of the original site geography or topography. The site contours may be overlaid with a reference grid of uniform grid elements in known fashion. The digitized site plans may be superimposed, viewed in two- or three- dimensions from various angles (e.g., profile and plan), and/or color coded to designate areas in which the site may need to be machined (e.g., removing earth and/or adding earth). Software may also estimate the quantity of earth required to be machined or moved, make cost estimates, and identify various site features and obstacles above or below ground as is known in the art.

Computer 52 of position module 50 may provide computer 62 with updated GPS data. Computer 62 may utilize this data in processing algorithms to update data associated with model 64 stored within database 66. Database 66 may determine the difference between the actual and desired site geographies of model 64 and use the updated GPS data to update and display model 64 in real time with a degree of accuracy measured in centimeters.

Computer 62 may provide data to symbol generator 75, allowing symbol generator 75 to control cathode 68. Cathode 68 may produce ray 74 of electrons, which may be focused by focusing coil 71. Ray 74 may travel through bulb 69 and be directed by deflecting plates 72 to strike the phosphors located on glass face 70 at a certain location, producing light ray 76. Light ray 76 may be emitted from CRT projector 67 in a direction corresponding to the location on glass face 70. Computer 62 may execute algorithms for controlling the components of CRT projector 67 to produce light rays 76 of a given direction and intensity.

In the refractive heads-up display shown in FIG. 3, light ray 76 may pass through collimating lens 73 and be transformed into a set of parallel beams. Light ray 76 may be projected onto windshields 18. Outside light 77 may combine with light ray 76 to form combined light 78, which may be reflected to the operator's eyes and allow the operator to view model 64 as projected by CRT projector 67. In the reflective heads-up display shown in FIG. 4, light ray 76 may be reflected off of curved windshields 18. Outside light 77 may combine with light ray 76 to form combined light 78, which may be reflected to the operator's eyes and allow the operator to view model 64 as projected by CRT projector 67. Since windshields 18 may be semi-transparent in both the refractive and reflective heads-up displays, the operator may simultaneously view a three-dimensional model of a design plan for work site 12 projected onto windshields 18 and the actual terrain visible beyond windshields 18, where the projected terrain appears to overlay the actual terrain in the perspective of the operator.

Three-dimensional positioning system 100 and associated display 65 may help to provide a method for calculating and displaying output describing three-dimensional model 64 to an operator. Display 65 may project output onto windshields 18 of operator station 16 so that operators may immediately compare the projected output with the actual condition of work site 12 without having to look away from windshields 18. The operators may alter their actions based on the comparison while still looking through windshields 18, thereby making the work more efficient.

It will be apparent to those skilled in the art that various modifications and variations can be made to the disclosed positioning system and display. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A positioning system, comprising:
a database for storing a site model, wherein the site model includes data indicative of a desired geography of a site environment and an actual geography of the site environment;
a first receiver for generating digital signals representing a real time position in three-dimensional space of at least a portion of a machine as the machine traverses the site environment;
a processor for receiving the signals and updating the site model to determine a difference between the data indicative of the desired geography and the data indicative of the actual geography; and
a display for projecting the site model onto at least one surface of an operator station of the machine so that an operator may simultaneously view the site model and the site environment.

2. The positioning system of claim 1, wherein the display includes a cathode ray tube projector.

3. The positioning system of claim 2, wherein the display is a refractive display.

4. The positioning system of claim 3, wherein the cathode ray tube projector includes a collimating lens.

5. The positioning system of claim 4, wherein the projected site model is configured to be viewable by an operator from different positions within an operator station.

6. The positioning system of claim 2, wherein the display is a reflective display.

7. The positioning system of claim 6, wherein the at least one surface is curved and includes at least one integrated collimating lens.

8. The positioning system of claim 1, wherein the display projects a plurality of colors corresponding to a plurality of aspects of the site model.

9. The positioning system of claim 1, wherein the database, the first receiver, the processor, and the display are located on the machine.

10. The positioning system of claim 9, further including a second receiver located remotely from the machine, wherein the second receiver is linked to the first receiver by a communication link configured to transmit three-dimensional position data.

11. The positioning system of claim 1, further including a third receiver for generating digital signals representing a real time position in three-dimensional space of a tool of the machine, wherein the third receiver is located on the tool.

12. The positioning system of claim 11, wherein the first, second, and third receivers are GPS receivers configured to receive satellite data.

13. The positioning system of claim 1, wherein the difference is updated in real time and stored in the database.

14. A method for providing positioning data to an operator, comprising:
storing data indicative of a desired geography of a site environment;
storing data indicative of an actual geography of the site environment;
receiving a real time position in three-dimensional space of at least a portion of a machine as the machine traverses the site;
updating the data indicative of the actual geography of the site environment based on the real time position;
determining a difference between the data indicative of the desired geography and the data indicative of the actual geography in real time;
updating and storing the difference; and
projecting data onto at least one surface of an operator station so that the data indicative of the desired geography, the data indicative of the actual geography, and the difference may be viewed simultaneously with the site environment by an operator.

15. The method of claim 14, wherein the display is a refractive display.

16. The method of claim 15, wherein the projected site model is configured to be viewable by an operator from different positions within the operator station.

17. The method of claim 14, wherein the display is a reflective display.

18. The method of claim 14, further including providing the real time position in three-dimensional space based on satellite data.

19. A machine having a positioning system, comprising:
a first receiver for generating digital signals representing a real time position in three-dimensional space of at least a portion of the machine as the machine traverses a site environment;
a first processor for receiving the signals;
a database for storing a site model, wherein the site model represents the desired geography of the site environment and the actual geography of the site environment;
a second processor for receiving data from the first processor to update the site model and to determine a difference between the desired geography and the actual geography, wherein the difference is updated in real time and stored in the database;
a display for projecting the site model onto at least one surface of an operator station of the machine so that an operator may simultaneously view the site model and the site environment; and
a tool, wherein the tool includes a second receiver for generating digital signals representing a real time position of the tool in three-dimensional space.

20. The machine of claim 19, wherein the display is a refractive display or a reflective display.
